(19) United States
(12) Patent Application Publication
(10) Pub. No.: US 2024/0090688 A1
(43) Pub. Date: Mar. 21, 2024

(54) Waterproof Massaging Pillow

(71) Applicant: Lisa Courtney-Ward, Appling, GA (US)

(72) Inventor: Lisa Courtney-Ward, Appling, GA (US)

(21) Appl. No.: 18/046,003

(22) Filed: Oct. 12, 2022

Related U.S. Application Data
(60) Provisional application No. 63/408,151, filed on Sep. 20, 2022.

(51) Int. Cl. A47G 9/10

(52) U.S. Cl. CPC A47G 9/1036; A47G 9/1045; A47G 9/1081; A47G 2009/005

(57) ABSTRACT

The therapeutic massaging device has a housing or cover, with a top surface, bottom surface, and sides, with the top surface having a head member, neck member, and a back member. The housing includes at least one motor and the motor vibrates portions of the top surface thus massaging the user's neck and back. The device includes one temperature control element that can be controlled by a smart phone. Further, the housing may have at least one speaker, at least one light source, and a plurality of fasteners. The device also has an interchangeable head member.

### CROSS-REFERENCE TO RELATED APPLICATION

The present application claims priority to, and the benefit of, U.S. Provisional Application No. 63/408,151, which was filed on Sep. 20, 2022, and is incorporated herein by reference in its entirety.

### FIELD OF THE INVENTION

The present invention relates generally to the field of personal comfort and therapeutic devices. More specifically, the present invention relates to a massaging pillow. The invention has a housing, with a head member, a neck member, and a back member. The housing includes at least one motor, further powered by at least one battery. The motor vibrates thus massaging the user's neck and back. The device also may have at least one heating element that further comforts the muscles of the user. Further, the housing may have at least one speaker that may be in electrical communication with the user's smart device. This allows the user to play their desired music or entertainment for further relaxation. The housing may further have at least one light source and a timer. The light source may have a plurality of functions, such as illuminate the area, alert the user of battery life, or synchronization with the user's speaker. The housing may also have a plurality of fasteners. The device also has an interchangeable head member that allows for further customization. The device provides the user with a way to release their tense muscles while floating in a body of water. Accordingly, the present disclosure makes specific reference thereto. Nonetheless, it is to be appreciated that aspects of the present invention are also equally applicable to other like applications, devices, and methods of manufacture.

### BACKGROUND

Many individuals suffer from aches and pains due to tense and sore muscles created by the physical and emotional stresses that an individual may encounter. Specifically, muscle aches and pains can be particularly difficult to deal with in the head, neck, and back region. There are plenty of methods to obtain relief but typically they are physically demanding or very time consuming. Further, many methods to pain relief, such as massages, can be expensive. Many individuals participate in water therapy methods such as hot tubs, pools, spas, or baths. However, using massage tools in the water can be impossible due to the fact the majority are electrical devices and exposure to water may cause the massage tools to short out.

Therefore, there exists a long-felt need in the art for an improved massage pillow. There also exists a long-felt need in the art for a waterproof massaging pillow and therapeutic device that provides a way for users to release back, neck and other body tension while in water, such as a swimming pool, spa, or hot tub. Further, there exists a long-felt need in the art for a waterproof massaging pillow or therapeutic device that allows a user to relax in water while simultaneously getting a massage and enjoying other relaxing features. There also exists a long-felt need in the art for a therapeutic device that allows a user to release their tense back and neck muscles without exerting much, if any, energy. There exists a long-felt need in the art for a massaging pillow that has a plurality of novel features and capabilities.

The subject matter disclosed and claimed herein, in one embodiment thereof, comprises a waterproof massaging pillow or therapeutic device. The invention has a housing with a head member, a neck member, and a back member. The housing includes at least one motor powered by at least one battery. The motor vibrates thus massaging the user's neck, back and other portions engaged with the massaging area. The device also may have at least one heating element that assists in loosening the muscles of the user. Further, the housing may have at least one speaker, at least one light source, and a plurality of fasteners. The device also has an interchangeable head member that allows for further customization.

In this manner, the waterproof massaging pillow of the present invention accomplishes all of the foregoing objectives and provides a novel personal massaging device. The invention provides a user with the ability to sit in a body of water such as a pool, hot tub, or spa and still receive the benefits of a massage to further loosen their tense muscles and relieve other body aches.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a waterproof massaging pillow or personal therapeutic device. The invention has a housing that has a top surface, bottom surface, and a pair of side surfaces. The top surface includes a neck portion or member, a head portion or member, and a back portion or member, at least one handle, and at least one strap secured to the housing. The housing is manufactured from a waterproof fabric. The waterproof fabric protects the interior electronics and cushion material from being saturated with water when used in a pool or other aquatic environment. The housing has a foam or sponge material that provides for a comfortable pillow feel for the user.

The therapeutic device of the present invention has a top surface with three distinct zones or areas, the first zone is near the leading edge of the top surface and adjacent the front side surface. The second area or zone is adjacent to the first zone and provides a raised area that extends above the top surface and provides shoulder support. The second area or zone is between the first zone and the third zone. The third zone or area provides a massaging function and may have contours, patterns, or other topographic features to enhance the massaging function. The third zone has a size which is larger than that of each of the first and second zones. The third zone is adjacent the trailing edge of the top surface and adjacent the bottom side edge. The second zone is larger than the first zone. Each of the leading and trailing edges of the therapeutic device are rounded and each of the side edges are generally square or flat. The top surface and bottom surface are defined by a side seam which defines the side edges of the therapeutic device.

The housing is further manufactured in any suitable size and shape known in the art. In the preferred embodiment, the back member or portion is rectangular, and has a plurality of grooves to add comfort. The neck portion or member is further rectangular and adds additional support. The head member or portion is preferably cylindrical in shape allowing a user to have a comfortable head support at any angle. The housing has a first, second and third portion for providing comfort to an individual that is lounging on the top surface of the housing.

The device has at least one handle positioned on one of the sides of the housing. The handle provides the user with a way to transport and carry the device with minimal effort. The device may also have a strap that is positioned across the front of the back member. This strap may go around the user's torso area to keep the pillow from floating or moving away from the user while it is in use. The strap prevents the user from having to reposition themselves during use.

The device may have at least one motor. The motor vibrates to create vibrations to the massage the user's neck and back. In one embodiment, the motor has a multitude of vibrational speeds and orientations. The motor is further powered by at least one battery.

The device may have at least one heating or cooling element. The heating or cooling element allows a user to apply a preferred temperature as part of a massage to aid in further loosening the tense muscles or relieving stress of the individual. In one embodiment, the heating or cooling element may have a plurality of settings (e.g., high, medium, or low), or alternatively may have a thermostat type of control allowing a user to program a specific temperature or range. In another embodiment, the heating or cooling element may only have one setting. The heating element is further powered by at least one battery.

The device may also have at least one light source. The light source may have a plurality of functions such as, but not limited to, notifying the user of the battery life left in the device or alerting others nearby that the massage pillow has been inverted in the water. The light source may further illuminate the pool or bathtub that the user is in for more enjoyable use. The light source is further powered by at least one battery.

The device may have at least button. In one embodiment, there is one button to control all the components of the device. In another embodiment, there are a plurality of buttons that function to operate separate components. The button further may be any button or switch known in the art.

The device has at least one housing fastener positioned on the housing. The housing fastener further attaches to the cooperating or corresponding member fastener positioned on the bottom of the head member. These fasteners allow a user to remove the head member. In differing embodiments, there may be a plurality of sizes and shapes of head members that a user may interchange on the massaging or therapeutic device. The fasteners would allow a user to be able to change the head member based on their preference or depending on the size of the user.

The device has at least one speaker. The speaker may be in electrical communication with the user's smart device via Wi-Fi, Bluetooth, or cellular data to play the users desired music, or other audio entertainment. In the preferred embodiment, the speaker is waterproof in that, the speaker will not be damaged by moisture. The speaker is further powered by at least one battery. In addition, a table or other screen may be provided in a waterproof cover and secured to the massage pillow so that an individual may watch video programing while receiving the therapeutic treatment.

In one embodiment, the device includes at least one fastener positioned on the side of the housing. This fastener can be undone to allow the user to be able to access inside the housing. This allows the user to be able to remove the heating or cooling element, speaker, lights, tablets, or any other electrical devices in order to wash and clean the massage pillow or therapeutic device.

The device has at least one remote control. The remote has at least one power button, at least one control button, at least one battery, at least one USB port, and indicia.

The remote has at least one power button. In one embodiment, there is one power button to turn off and on all electronic features in the device. In another embodiment, there are a plurality of power buttons, in that each one controls a separate electronic component of the device. The remote has at least one control button. In the preferred embodiment, there are a plurality of control buttons, wherein each one controls a singular electrical component. Further, the remote is powered by at least one battery. The battery may further be recharged via USB port. The USB port may be any USB port known in the art. The remote also may have a plurality of indicia.

Accordingly, the waterproof massaging pillow device of the present invention is particularly advantageous as it provides users with a novel means of releasing tension and stress while in a body of water. Further, the device provides a relaxing waterproof pillow that also has a plurality of electronic capabilities. In this manner, the waterproof massaging pillow device overcomes the limitations of existing problems known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a waterproof massaging pillow or therapeutic device of the present invention in accordance with the disclosed architecture;

FIG. 2 illustrates an exploded side view of one potential embodiment of a waterproof massaging pillow or therapeutic device of the present invention in accordance with the disclosed architecture;

FIG. 3 illustrates a perspective view of one potential embodiment of a waterproof massaging pillow or therapeutic device of the present invention in accordance with the disclosed architecture; and

FIG. 4 illustrates a perspective view of one potential embodiment of a remote of one potential embodiment of a waterproof massaging pillow or therapeutic device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved massage pillow or therapeutic device. There exists a long-felt need in the art for a waterproof massaging pillow or therapeutic device that provides a way for users to release back and neck tension and other stresses while relaxing in an aquatic setting, such as a bathtub, hot tub, spa or pool. Further, there exists a long-felt need in the art for a waterproof massaging pillow or therapeutic device that allows a user to relax in water, while simultaneously getting a massage and other treatment. There also exists a long-felt need in the art for a device that allows a user to release their tension and stress without exerting any energy. There exists a long-felt need in the art for a massaging pillow that has a plurality of novel features and capabilities.

The present invention, in one exemplary embodiment, is comprised of a waterproof massaging pillow or therapeutic device. The device includes a housing, having a top surface, a bottom surface and side surfaces with the top surface having a head member, a back member, and a neck member. The back member or portion may have a number of contoured features to enhance the massaging treatment. The housing includes at least one vibrational motor that massages a user's back. The motor is powered by at least one battery and can have different vibrational settings. In one embodiment, the device may have at least one programmable temperature control element, such as a heating or cooling zone, to regulate the temperature of the device when the water is cold or if the individual wants to add heat or cooling to their massage to further enhance the therapeutic treatment. The temperature control element is powered by at least one battery and can have different temperature settings. In another embodiment, the device may have at least one speaker that allows a user to listen to the entertainment of their choice while the device is in use. The invention may also have a waterproof sleeve to allow a user to insert a tablet or other device so as to enjoy video content.

In yet another embodiment, the device may have at least one programmable light source. The light source can provide additional light if the body of water is poorly lit, if the individual wants light to mimic the audio entertainment selected on the smart device, or if a user needs additional illumination for reading. The light source also may notify the user of the battery life of the device and can be used for emergency purposes.

The device further may include an interchangeable head member that is attached and detached via at least one head fastener and at least one housing fastener. The head member or portion is positioned near a front edge of the top surface and adjacent the front edge surface. Further, the device includes at least one fastener that allows a user to remove the electronical components and cushions to be able to wash the housing. The device also may have at least one remote to further control and operate the device.

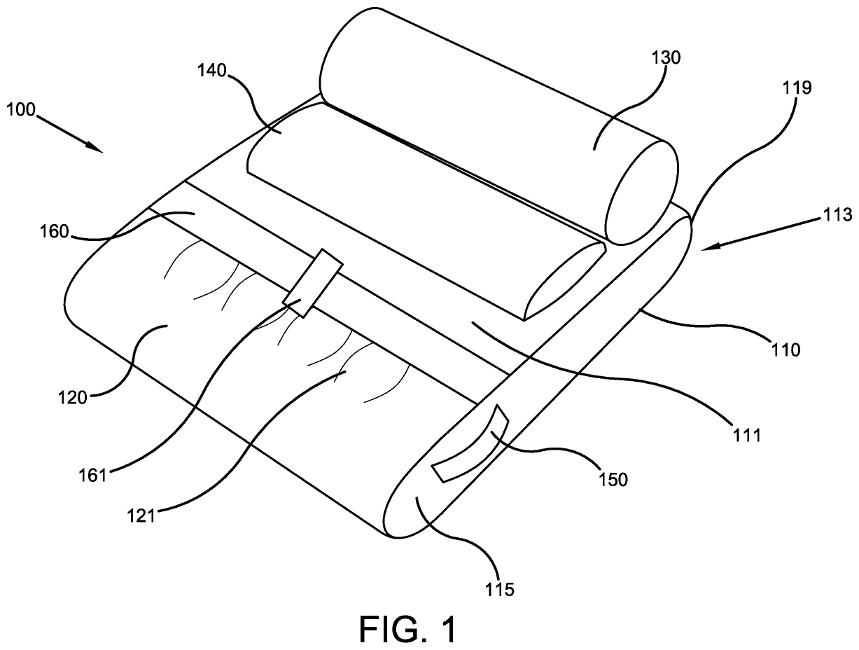

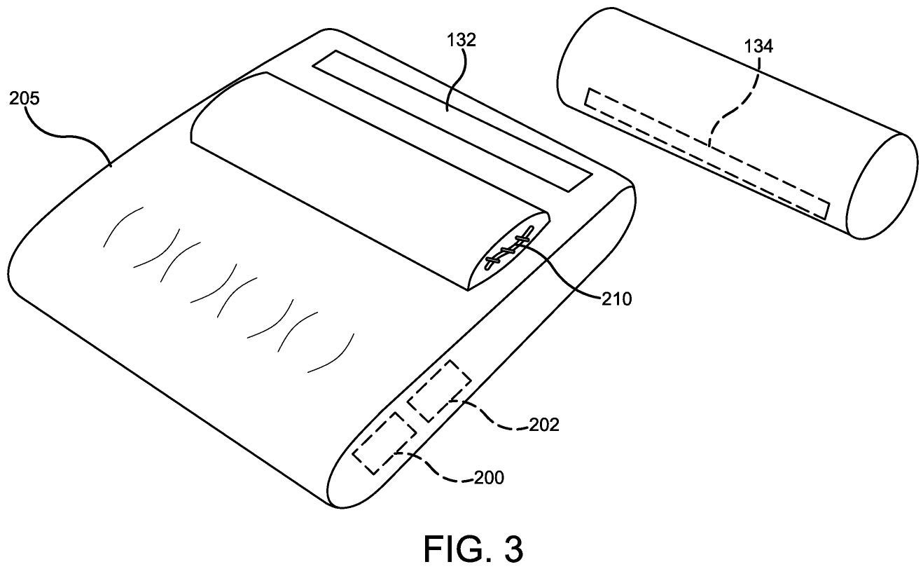

Referring initially to the drawings, FIG. 1 illustrates a perspective view of one potential embodiment of a waterproof massaging pillow or therapeutic device 100 of the present invention in accordance with the disclosed specification. The device 100 has a housing 110, with a top surface 111, a bottom surface 113 (the surface on the back side), a pair of side edges 115 and 117 (see FIG. 3), a front edge 119 and a trailing edge 121. The top surface 111 has a neck member 140, a head member 130, and a back member 120, at least one handle 150, and at least one extendable safety strap 160. The strap may have a buckle 161 to aid in securing the strap to the user.

The housing or cover 110 is manufactured from a waterproof fabric such as, but not limited to: acrylic plastic, polycarbonate, high-density polyethylene, PUL, polyester, neoprene, Naugahyde, laminated cotton, nylon, waxed cotton, poplin, oil cloth, polyester fleece, vinyl, pleather, plastic, or combinations thereof. The waterproof fabric protects the interior electronics and cushion material from being saturated by water after extended use. The housing or cover 110 has a foam or sponge material, such as a polyurethane or hypoallergenic foam, that provides a comfortable pillow feel for the user. The filler material may be any suitable material such as, but not limited to: polyurethane foam, polyester foam, ethafoam, memory foam, lux foam, rebond foam, latex foam, cellulose sponge, compressed cellulose sponge, natural sea sponge, woven sponge, polyethylene sponge, dental sponge, or combinations thereof. The interior filler material provides a comfortable pillow for the user to lie on while using the therapeutic device of the present invention.

The housing 110 is further manufactured in any suitable size and shape known in the art. In the preferred embodiment, the back member or third area 120 is generally rectangular, and has a plurality of grooves, contours, or other topography to add comfort and enhance the massage effect. The neck and shoulder member or second area or zone 140 is also rectangular and adds additional support to the neck and shoulder region. The head member or first area or zone 130 is preferably cylindrical in shape allowing a user to have a comfortable head support at any angle. The first zone has a higher elevation than either of the second or third zones of the therapeutic device, which allows the legs of the users to dangle in the water while the head, shoulders and back remain out of the water with the head at the highest elevation.

The therapeutic device 100 has at least one handle 150 positioned on the side of the housing 110. The handle 150 provides the user with a way to transport and carry the device 100 with minimal effort. The therapeutic device 100 may also have a safety strap 160 that is positioned across the front of the back member 120. This strap 160 may go around the user's torso to keep the pillow from floating or moving away from the user while it is in use. The strap 160 prevents the user from having to reposition themselves during use.

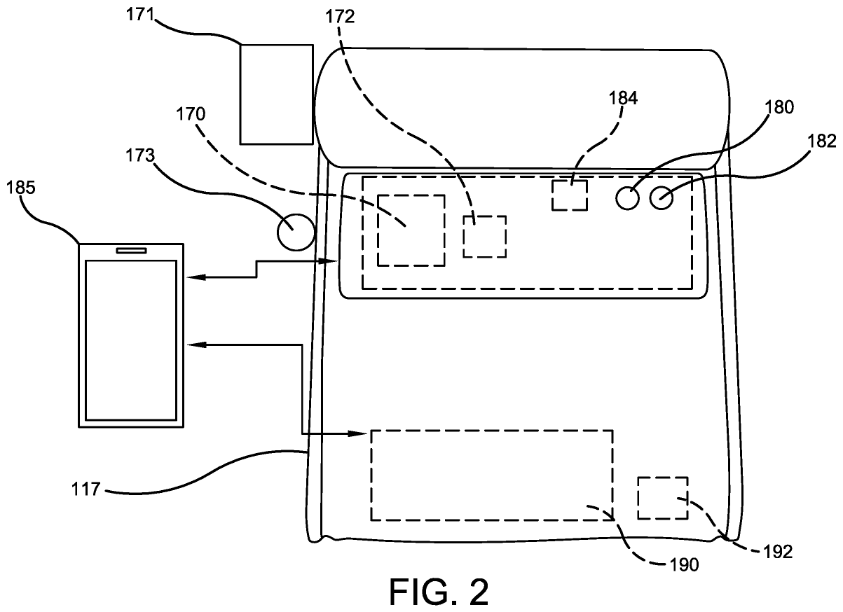

FIG. 2 illustrates an exploded side view of one potential embodiment of a waterproof massaging pillow or therapeutic device 100 of the present invention in accordance with the disclosed specification. The device 100 may have at least one motor 170, at least one temperature control element 190, at least one battery 192, 172, 184, at least one button 180, and at least one light 182. The temperature control element 190, motor 170, as well as the speaker 200 and light source 182 may all be operated independently or the user can selectively operate one element with one or more other elements. For example, the user can operate the motor 170 to create a vibratory massage while at the same time, operating the temperature control unit and the speaker. Any combinations of operation are possible and each of the electronic components are independently programmable.

The device 100 may have at least one motor 170. The motor 170 vibrates in order to apply the massage to the third zone or back portion 120. In one embodiment, the motor 170 has a multitude of vibrational speeds and orientations. The motor 170 may be any motor known to one skilled in the art. The motor 170 is further powered by at least one battery 172. The battery 172 can be in the form of an alkaline, nickel-cadmium, nickel-metal hydride battery, etc., such as any 3V-12-volt DC battery 172 or other conventional battery 172 such as A, AA, AAA, etc., that supplies power to the motor 170. Throughout this specification the terms “battery” and “batteries” may be used interchangeably to refer to one or more wet or dry cells or batteries 172 of cells in which chemical energy is converted into electricity and used as a source of DC power. References to recharging or replacing batteries 172 may refer to recharging or replacing individual cells, individual batteries 172 of cells, or a package of multiple battery cells as is appropriate for any given battery 172 technology that may be used.

The device 100 may further include at least one temperature control element 190. The temperature control element 190 allows a user to have a temperature enhanced massage for further loosening the tense muscles i the user's back and neck. The temperature control element 190 may be any suitable element known in the art such as, but not limited to: ceramic heater, PTC, aluminum heater, quartz heater, air process heater or chiller, evaporative cooler, cartridge heater, tubular heater, strip heater or chiller, band heater or chiller, etched foil heater, heated coils, heated or cooled wires, hot or cold air, or combinations thereof. In one embodiment, the temperature control element 190 may have a plurality of settings or be controllable by a programmable thermostat so that a user can set any desired temperature and the element 190 will maintain the temperature setting. The thermostat may be controlled by a smart device 185. In another embodiment, the temperature control element 190 may only have one setting. The temperature control element 190 is further powered by at least one battery 192.

The device 100 may also have at least one light source 182. The light source 182 may have a plurality of functions such as notifying the user of the battery life left in the device 100 (i.e., green light for full battery, yellow light for half battery, and red light for low battery.) The light source 182 may further illuminate the pool, aquatic area, or bathtub that the user is in for more enjoyable use or to create a personalized light show to correspond to the music or audio programs being listened to. The light source 182 may be a plurality of light sources such as, but not limited to: LED light, LCD light, fluorescent light, white light, spotlight, area light, fiber optic illuminator, incandescent, halogen, or combinations thereof. The light source 182 is further powered by at least one battery 184, the battery 184 may be any battery known to one skilled in the art.

The device 100 may have at least button or switch 180. In one embodiment, there is one button 180 to control all the components of the device 100. In another embodiment, there are a plurality of buttons 180 that function to operate separate components (i.e., one button 180 to operate the motor 170, another button 180 to operate the heating element 190.) The button or switch 180 further may be any button known in the art. The device 100 may also be provided with a protective sleeve 171 to hold a tablet or screen to allow a user to watch video programming. The sleeve 171 may be repositionable about a hinge to change the viewing angle for the user. In addition, one or more cup or accessory holders 173 may be attached to the side edges of the device 100 to hold consumable items as well as other personal items such as a smartphone.

FIG. 3 illustrates a perspective view of one potential embodiment of a waterproof massaging pillow or therapeutic device 100 of the present invention in accordance with the disclosed specification. The device 100 includes at least one housing fastener 132, at least one member fastener 134, at least one speaker 200, and at least one battery 202. The top surface 111 and bottom surface 113 are bounded on the sides by a seam 205 to define the end edges.

The therapeutic device 100 has at least one housing fastener 132 positioned on the housing 110. The housing fastener 132 may be any fastener such as, but not limited to: magnet, adhesive, hook and loop fastener, tongue and groove fastener, or combinations thereof. The housing fastener 132 further attaches to the cooperating or corresponding member fastener 134 positioned on the bottom of the head member 130. The member fastener 132 further may be any fastener that cooperates or corresponds with the housing fastener 132. These fasteners 132, 134 allow a user to easily remove the head member 130. In differing embodiments, there may be a plurality of sizes and shapes of head members 130 that a user may interchange on the therapeutic device 100. The fasteners 132, 134 would allow a user to be able to change the head member 130 based on their preference.

The therapeutic device 100 has at least one speaker 200. The speaker 200 may be in electrical communication with the user's smart device via Wi-Fi, Bluetooth, or cellular data to play the user's desired music, or other entertainment. The speakers 200 may be any speaker known in the art. In the preferred embodiment, the speaker 200 is waterproof in that the speaker 200 will not be damaged by moisture. The speaker 200 is further powered by at least one battery 202. In a further embodiment, the speaker 200 may be integrated with the lighting feature 182 so that a particular lighting effect may be created by the individual.

In one embodiment, the device 100 includes at least one fastener 210 positioned on the side of the housing or cover 110. This fastener 210 can be undone to allow the user to be able to access inside the device 100. This allows the user to be able to remove the temperature control element 190, speaker 200, or any other electrical devices in order to wash the housing or cover 110. The fastener 210 may be any fastener such as, but not limited to, hook and loop, snap button, or preferably zipper.

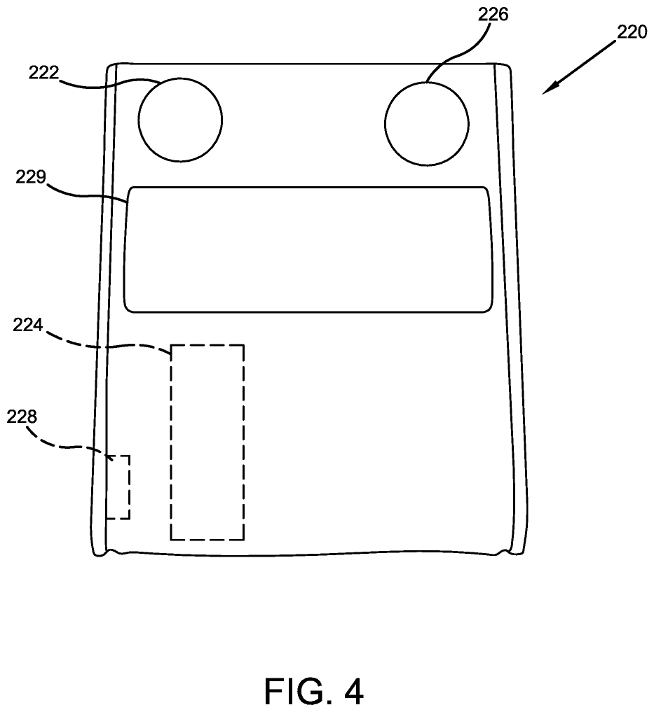

FIG. 4 illustrates a perspective view of one potential embodiment of a remote 220 of one potential embodiment of a waterproof massaging pillow device 100 of the present invention in accordance with the disclosed specification. The remote 220 has at least one power button 222, at least one control button 226, at least one battery 224, at least one USB port 228, and indicia.

The remote 220 further includes at least one power button 222. In one embodiment, there is one power button 222 to turn off and on all electronic features of the device 100. In another embodiment, there are a plurality of power buttons or switches 222, in that each one controls a separate electronic component of the device 100. The remote 220 further includes at least one control button 226. In the preferred embodiment, there are a plurality of control buttons 226 with each controlling a singular electrical component. (i.e., one control button 226 changes the vibration intensity of the motor 170, while another control button 226 changes the output from the temperature control element 190.)

Further, the remote 220 is powered by at least one battery 224. The battery 224 can be in the form of an alkaline, nickel-cadmium, nickel-metal hydride battery, etc., such as any 3V-12-volt DC battery 224 or other conventional battery 224 such as A, AA, AAA, etc., that supplies power to the remote 220. Throughout this specification the terms “battery” and “batteries” may be used interchangeably to refer to one or more wet or dry cells or batteries 224 of cells in which chemical energy is converted into electricity and used as a source of DC power. References to recharging or replacing batteries 224 may refer to recharging or replacing individual cells, individual batteries 224 of cells, or a package of multiple battery cells as is appropriate for any given battery 224 technology that may be used. The battery 224 may further be recharged via a USB port 228. The USB port 228 may be any USB port known in the art such as, but not limited to: USB-A, USB-B, Micro-B, Micro-USB, Mini-USB, USB-C, 9 v/12 v power supply, etc. The remote 220 also may have a plurality of indicia 229 such as, a pattern, a logo, an emblem, an image, a symbol, a design, a letter, a word, a character, an animal, an advertisement, or a brand.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “waterproof massaging pillow device” and “device” are interchangeable and refer to the waterproof massaging pillow or therapeutic device 100 of the present invention.

Notwithstanding the foregoing, the waterproof massaging pillow or therapeutic device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the waterproof massaging pillow or therapeutic device 100 as shown in the FIGS. are for illustrative purposes only, and that many other sizes and shapes of the waterproof massaging pillow or therapeutic device 100 are well within the scope of the present disclosure. Although the dimensions of the waterproof massaging pillow or therapeutic device 100 are important design parameters for user convenience, the waterproof massaging pillow or therapeutic device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A therapeutic device comprising:
a housing comprising a top surface, a bottom surface, a pair of side edges, a leading edge and a trailing edge;
a first zone positioned on the top surface and adjacent to the leading edge;
a second zone positioned on the top surface;
a third zone positioned on the top surface adjacent to the trailing edge, wherein the second zone is also positioned on the top surface between the first and second zones;
wherein the first zone has a higher elevation than either of the second or third zones; and
further wherein the third zone being larger than either of the first and second zones.

2. The therapeutic device as recited in claim 1, wherein the third zone comprises a pattern, a contour or a topography.

3. The therapeutic device as recited in claim 1, wherein the first zone comprises a removable head member.

4. The therapeutic device as recited in claim 3, wherein the removable head member is secured by a fastener to the first zone.

5. The therapeutic device as recited in claim 1, wherein each of the leading and trailing edges are rounded.

6. The therapeutic device as recited in claim 1, wherein the third zone comprises a temperature control element.

7. The therapeutic device as recited in claim 6, wherein the temperature control element provides a heating or a cooling.

8. The therapeutic device as recited in claim 7, wherein the temperature control element is controlled by a programmable thermostat that is configured to be controlled by a smart phone.

9. The therapeutic device as recited in claim 1 further comprising a motor to provide a vibration to the top surface of the therapeutic device.

10. The therapeutic device as recited in claim 1, wherein the housing is a washable cover.

11. The therapeutic device as recited in claim 1 further comprising a strap extending over the third zone to hold a torso of a user in position.

12. A massage pillow comprising:
a waterproof housing comprised of a top surface, a bottom surface and a pair of side surfaces;
a head member positioned on the top surface;
a back member positioned on the top surface;
a neck member positioned on the top surface, wherein the back member is larger than either of the head member and neck member, and further wherein the head member has a higher elevation than either of the neck member or the back member;
a motor for supplying vibrations to the back member; and
a temperature control element.

13. The massage pillow as recited in claim 12, wherein the temperature control element provides a heating or a cooling.

14. The massage pillow as recited in claim 13, wherein the temperature control element is controlled by a programmable thermostat.

15. The massage pillow as recited in claim 12, wherein the head member is removable from the top surface of the housing.

16. The massage pillow as recited in claim 12 further comprising a speaker and a light source, wherein each of the speaker and the light source are configured to be wirelessly controlled by a smart phone and are powered by at least one battery.

17. The massage pillow as recited in claim 12, wherein the motor and temperature control element are each programmable and configured to be controlled by a smartphone and may be operated independently of one another or together.

18. The massage pillow as recited in claim 17, wherein each of the motor and temperature control element are powered by at least one battery.

19. A therapeutic massage device comprising:
a cover comprised of a top surface, bottom surface and a pair of side edges;
wherein the top surface is comprised of a head member, a neck member and a back member;
wherein the head member is removable from the top surface of the cover;
wherein the neck member is rectangular and is positioned in between the head member and the back member;
wherein the back member is comprised of a pattern, a contour or a topography and is lower than each of the neck and head members;
a motor for providing vibration to the top surface; and
a temperature control element for providing heating or cooling to the top surface, wherein each of the motor and the temperature control element is configured to be controlled by a smart phone.

20. The therapeutic massage device, as recited in claim 19 further comprising a light source, a speaker and a power source for powering the light source and speaker.
